(19) United States
(12) Patent Application Publication
(10) Pub. No.: US 2024/0378021 A1
(43) Pub. Date: Nov. 14, 2024

(54) Increasing the Entropy of Random Numbers

(71) Applicant: Infineon Technologies AG, Neubiberg (DE)

(72) Inventors: Rainer Göttfert, Putzbrunn (DE); Gerd Dirscherl, Munchen (DE); Berndt Gammel, Markt-Schwaben (DE); Wieland Fischer, Munchen (DE)

(21) Appl. No.: 18/659,610

(22) Filed: May 9, 2024

(30) Foreign Application Priority Data
May 12, 2023 (DE) 102023112670.9

(51) Int. Cl. G06F 7/58

(52) U.S. Cl. CPC G06F 7/588

(57) ABSTRACT

Approaches proposed in the present case relate to the process of increasing the entropy of a random number, wherein a plurality of random processes each provide a random number, the plurality of random numbers are linked to form a combined random number, and at least one of the random numbers has previously been mapped to another random number.

### TECHNICAL FIELD

The present application is related to the generation of random numbers, e.g., for cryptographic applications.

### BACKGROUND

Perfect random numbers have a per-bit entropy of 1 (100%). In many applications, in particular cryptographic applications, random numbers that are as good as possible, that is to say random numbers which come as close as possible to the entropy of 1, are required. For example, noise sources (also referred to as noise generators) are used to generate random numbers. A multiplicity of possible implementations for noise sources, for example analog or digital noise generators, are known.

So-called S-boxes are known as basic components of cryptography: an S-box is a substitution operation for converting one binary number into another binary number. Such mapping may be invertible (bijective) or compressing, for example.

### SUMMARY

An object of several embodiments of the invention described herein is to increase the entropy of random numbers in order to meet high cryptographic security requirements. This object may be achieved according to the features of the independent claims.

Examples proposed herein may be based on at least one of the following solutions. In particular, combinations of the following features can be used to achieve a desired result. The features of the method can be combined with any (one) feature(s) of the apparatus or vice versa.

In order to achieve the object, a method for increasing the entropy of a random number is proposed,
in which a plurality of random processes each provide a random number,
in which the plurality of random numbers are linked to form a combined random number, wherein at least one of the random numbers has previously been mapped to another random number.

The mapping of a random number to another random number may comprise permutation or resorting.

The combined random number may be used in a cryptographic method. Each random process may comprise at least one physical random process.

In principle, any mechanism that provides a (random) number that appears to be arbitrary to some extent can be used as the random process. The random number may be a number with more or less entropy. Ultimately, such a random number can also be generated deterministically or by a (pseudo-) random number generator. Since the entropy is increased by combining and mapping the plurality of random numbers, possibly lower requirements can be imposed on the entropy of the individual random numbers.

In some embodiments, the random number is mapped to the other random number by means of at least one S-box. In some embodiments, the S-box is a bijective S-box or a compression S-box. The random process and a digitizer may be part of a noise source.

In some embodiments, the random number is mapped to the other random number by means of the digitizer. In some embodiments, the plurality of random numbers are linked to form the combined random number by means of at least one XOR combination, in particular by means of at least one XOR gate.

The XOR combination may be implemented by means of XOR gates or other logic gates. In particular, an XOR combination of more than 2 bits can be divided into a plurality of 2-bit XOR combinations.

For example, it is possible to choose an implementation which links noise sources by means of XOR gates. One advantage of using XOR combinations is that an exact qualitative statement, and therefore documentation, of the increase in entropy is possible.

In some embodiments, mapping of the at least one random number to the other random number which increases the entropy of the combined random number is determined. In some embodiments, mapping of the at least one random number to the other random number which increases the entropy of the combined random number is determined by testing a multiplicity of mappings.

Such testing can be carried out, for example, by means of a computer search: all (or a subset of all) existing S-boxes can thus be tried out and the entropy of the combined random number is determined for each selected S-box or set of S-boxes. The at least one S-box that can be implemented most easily or most favorably (with regard to at least one target variable, for example space, costs, time, effort etc.) can then be selected from the best S-boxes.

In order to achieve the object, an apparatus for increasing the entropy of a random number is also proposed, wherein the apparatus has a processing unit which is configured to carry out the steps of one or more of the methods described herein.

An apparatus for increasing the entropy of a random number is also proposed,
having a plurality of random number generators, each of which provides a random number,
having at least one mapping unit which can be used to map at least one of the random numbers to at least one other random number, and
having a combining unit which is coupled to the random number generators and to the at least one mapping unit in such a manner that a combined random number can be determined on the basis of the random numbers and the at least one other random number.

Each random number generator may correspond to a random process or may comprise at least one random process.

In particular, it is an option for the random number from the mapping unit to be processed, instead of the random number determined by the random number generator, by the combining unit for that random number generator which is coupled to the mapping unit. If a mapping unit is provided for each random number generator, only the mapped random numbers can be processed in the combining unit.

In some embodiments, the mapping unit comprises at least one bijective and/or at least one compression S-box.

It is an option for the mapping unit to have a multistage design or for multistage mappings, possibly with interposed XOR gates, to be implemented.

In some embodiments, the combining unit comprises at least one XOR combination.

In some embodiments, the random number generator and the mapping unit are part of a noise source.

In this case, the mapping unit can also be referred to as a digitizer.

The above-described properties, features and advantages of this invention and the manner in which they are achieved are described below in connection with a schematic description of exemplary embodiments which are explained in more detail in connection with the drawings. In this case, identical or identically acting elements can be provided with the same reference signs for clarity.

### BRIEF DESCRIPTION OF THE FIGURES

FIG. 1 shows a group of a multiplicity of noise sources which are interconnected via an XOR gate.

FIG. 2 shows a group of a multiplicity of noise sources with S-boxes which are interconnected via an XOR gate.

FIG. 3 shows an exemplary arrangement for determining a combined random word by means of two noise sources which are interconnected via an XOR gate.

FIG. 4 shows an exemplary arrangement for determining a combined random word by means of two paths which are interconnected via an XOR gate, wherein each path comprises a noise source and an S-box.

FIG. 5 shows an exemplary arrangement for increasing the entropy by means of two noise sources and a bijective S-box.

FIG. 6 shows an exemplary arrangement for increasing the entropy by means of two noise sources and two compression S-boxes.

FIG. 7 shows a section of the arrangement according to FIG. 6, where the S-boxes are implemented by means of XOR gates, for example.

FIG. 8 shows a table with exemplary probability distributions for a plurality of noise sources.

FIG. 9 shows an exemplary arrangement for increasing the entropy by means of four noise sources and a plurality of bijective and compression S-boxes.

FIG. 10 shows an exemplary arrangement for increasing the entropy by modifying a digitizer arranged in the noise source.

### DETAILED DESCRIPTION

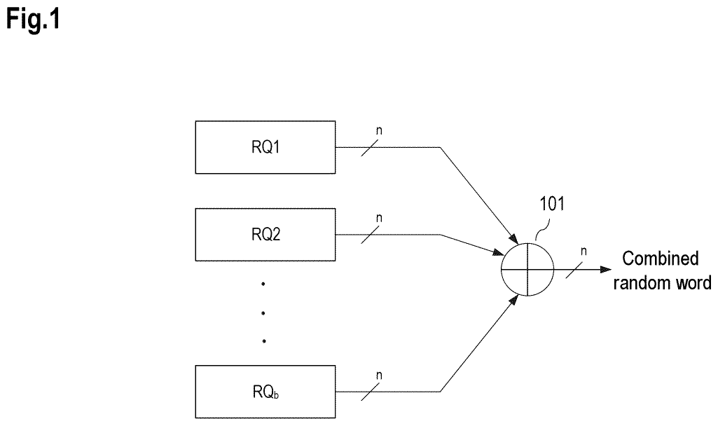

FIG. 1 shows an arrangement with b≥2 noise sources RQ1, RQ2, . . . , RQ_{b} which are connected to one another via an XOR gate 101.

The noise sources RQ1, RQ2, . . . , RQ_{b} generate random words (also called random vectors or random numbers) with a width of n bits independently of one another, wherein each noise source has a specific entropy.

b random words are generated per unit time, for example for each clock cycle of a processor unit (CPU), each of which random words has an entropy corresponding to the individual noise source RQ1, RQ2, . . . , RQ_{b}. Combining the noise sources via the XOR gate 101 causes an increase in the entropy (i.e. an entropy compression in the random word). The entropy can be increased further by using S-boxes S1, S2, . . . , S_{b} downstream of the noise sources.

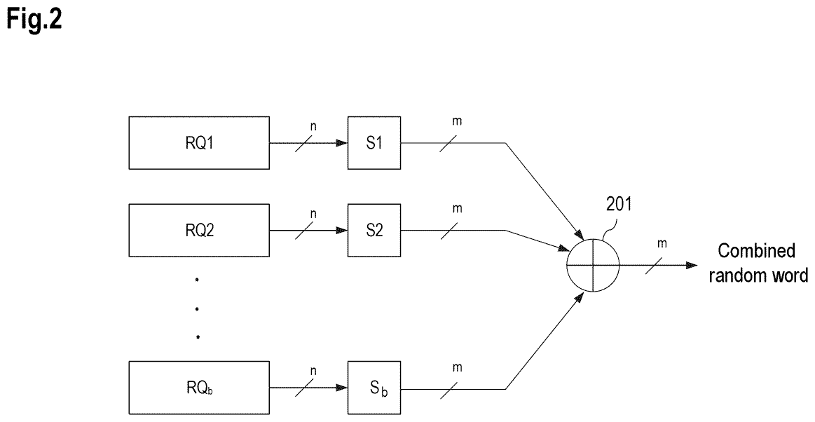

FIG. 2 shows an exemplary arrangement which, building on FIG. 1, has one S-box S1, S2, . . . , S_{b} each in the path between the noise source RQ1, RQ2, . . . , RQ_{b} and the XOR gate 201.

Examples described herein determine those S-boxes which increase the entropy of the combined random word in a group of noise sources. This entropy increase may be an optimization, in particular a maximization, of the entropy. For example, that at least one S-box which contributes most to increasing the entropy can be determined (and used) from a set of S-boxes. A plurality of S-boxes can also be used in this sense, for example those two S-boxes which result in the greatest possible increase in the entropy (for example with regard to a predefined (maximum) implementation outlay).

The following cases are considered by way of example:
Case 1 bijective S-boxes: m=n, the number of bits at the input of the S-box is identical to the number of bits at its output.
Case 2 compression S-boxes: m<n, the number of bits at the input of the S-box is greater than the number of bits at its output; the bits are reduced or compressed.

The b noise sources in the group of noise sources operate independently of one another, in particular. An individual noise source is memoryless or has a short-term memory. In the case of a memoryless noise source, the random word generated at the time t is (statistically) independent of all random words generated before it, that is to say in particular statistically independent of the random word generated at the time t−1. In the case of a noise source with a short memory, the random word generated at the time t depends on a few predecessor words. Noise sources with a short-term memory can be modeled by means of Markov chains. In the Markov chain model, the stationary probability distribution is first of all calculated and is then taken as a basis for the further analysis. The case of a noise source with a short-term memory can therefore be attributed to the case of the memoryless noise source.

### Bijective S-Boxes

Bijective functions maintain entropy, that is to say the random word before and after a bijective S-box has the same entropy. Nevertheless, the presence of bijective S-boxes in the group of noise sources influences the entropy value of the combined random number after the XOR gate.

This is explained, by way of example, on the basis of a group of noise sources comprising two noise sources, each of which produces a random word with a width of 2 bits. They are therefore two memoryless noise sources RQ1 and RQ2 which generate random words X and Y with a width of 2 bits for each CPU clock cycle. The 2-bit random words generated may assume four different values:

$$0 := ( \begin{matrix}0 \\ 0\end{matrix} ) , 1 := ( \begin{matrix}1 \\ 0\end{matrix} ) , 2 := ( \begin{matrix}0 \\ 1\end{matrix} ) , 3 := ( \begin{matrix}1 \\ 1\end{matrix} ) .$$

The four values are assumed with specific, possibly constant (and generally different) probabilities. These probabilities can be used to calculate the probabilities for the XOR sum Z=X⊕Y, which then result in the entropy H(Z) of the combined random word.

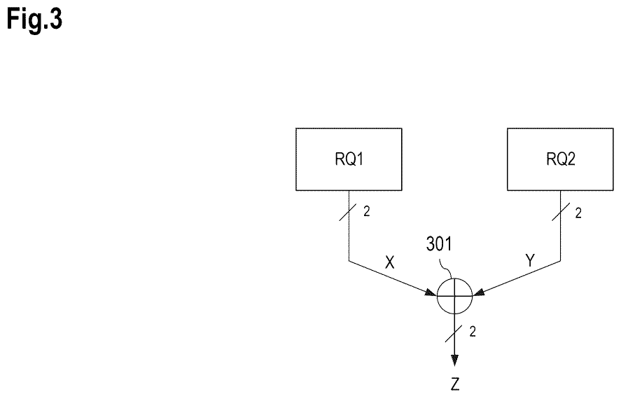

FIG. 3 shows an exemplary arrangement (without S-boxes) with the two noise sources RQ1 and RQ2, each of which delivers random words X and Y with a width of 2 bits to the inputs of an XOR gate 301. A random word Z with a width of 2 bits is generated at the output of the XOR gate 301 for each clock cycle and can assume values from 0 to 3. The associated probabilities W₀ to W₃ are:

$${W}_{0} = Pr ( Z = 0 ) = Pr ( X = 0 ) \cdot Pr ( Y = 0 ) + Pr ( X = 1 ) \cdot Pr ( Y = 1 ) + Pr ( X = 2 ) \cdot Pr ( Y = 2 ) + Pr ( X = 3 ) \cdot Pr ( Y = 3 ) ;$$

$${W}_{1} = Pr ( Z = 1 ) = Pr ( X = 0 ) \cdot Pr ( Y = 1 ) + Pr ( X = 1 ) \cdot Pr ( Y = 0 ) + Pr ( X = 2 ) \cdot Pr ( Y = 3 ) + Pr ( X = 3 ) \cdot Pr ( Y = 2 ) ;$$

$${W}_{2} = Pr ( Z = 2 ) = Pr ( X = 0 ) \cdot Pr ( Y = 2 ) + Pr ( X = 1 ) \cdot Pr ( Y = 3 ) + Pr ( X = 2 ) \cdot Pr ( Y = 0 ) + Pr ( X = 3 ) \cdot Pr ( Y = 1 ) ;$$

$${W}_{3} = Pr ( Z = 3 ) = Pr ( X = 0 ) \cdot Pr ( Y = 3 ) + Pr ( X = 1 ) \cdot Pr ( Y = 2 ) + Pr ( X = 2 ) \cdot Pr ( Y = 1 ) + Pr ( X = 3 ) \cdot Pr ( Y = 0 ) .$$

In this case, Pr(K=1) denotes the probability of the random word K assuming the value 1.

The probabilities W₀, W₁, W₂ and W₃ result in the entropy of the random word Z as

$$H ( Z ) = - {\sum }_{i = 0}^{3} {W}_{i} {log}_{2} ( {W}_{i} ) .$$

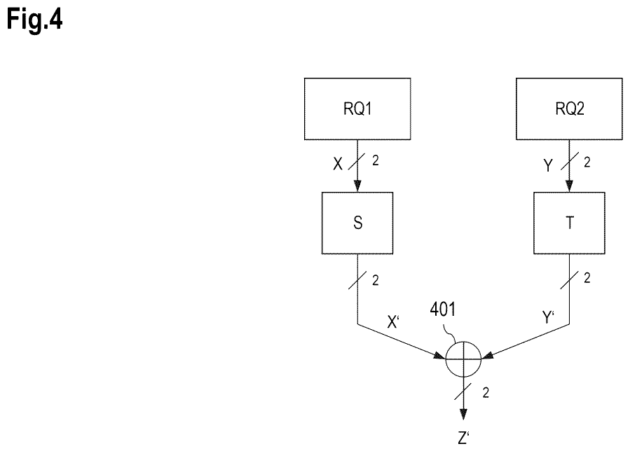

Building on FIG. 3, FIG. 4 shows an exemplary arrangement with bijective S-boxes S and T in the path between the noise source and the XOR gate 401. The noise source RQ1 delivers a random word X with a width of 2 bits to the input of the S-box, via the output of which a modified random word X′ with a width of 2 bits is delivered to the first input of an XOR gate 401. The noise source RQ2 delivers a random word Y with a width of 2 bits to the input of the S-box T, via the output of which a modified random word Y′ with a width of 2 bits is made available to the second input of the XOR gate 401. A random word Z′ with a width of 2 bits, that can assume values from 0 to 3, is generated at the output of the XOR gate 401 for each clock cycle. The associated probabilities V₀ to V₃ are:

$${V}_{0} = Pr ( {Z}^{′} = 0 ) = Pr ( X = {S}^{- 1} ( 0 ) ) \cdot Pr ( Y = {T}^{- 1} ( 0 ) ) + Pr ( X = {S}^{- 1} ( 1 ) ) \cdot Pr ( Y = {T}^{- 1} ( 1 ) ) + Pr ( X = {S}^{- 1} ( 2 ) ) \cdot Pr ( Y = {T}^{- 1} ( 2 ) ) + Pr ( X = {S}^{- 1} ( 3 ) ) \cdot Pr ( Y = {T}^{- 1} ( 3 ) ) ;$$

$${V}_{1} = Pr ( {Z}^{′} = 1 ) = Pr ( X = {S}^{- 1} ( 0 ) ) \cdot Pr ( Y = {T}^{- 1} ( 1 ) ) + Pr ( X = {S}^{- 1} ( 1 ) ) \cdot Pr ( Y = {T}^{- 1} ( 0 ) ) + Pr ( X = {S}^{- 1} ( 2 ) ) \cdot Pr ( Y = {T}^{- 1} ( 3 ) ) + Pr ( X = {S}^{- 1} ( 3 ) ) \cdot Pr ( Y = {T}^{- 1} ( 2 ) ) ;$$

$${V}_{2} = Pr ( {Z}^{′} = 2 ) = Pr ( X = {S}^{- 1} ( 0 ) ) \cdot Pr ( Y = {T}^{- 1} ( 2 ) ) + Pr ( X = {S}^{- 1} ( 1 ) ) \cdot Pr ( Y = {T}^{- 1} ( 3 ) ) + Pr ( X = {S}^{- 1} ( 2 ) ) \cdot Pr ( Y = {T}^{- 1} ( 0 ) ) + Pr ( X = {S}^{- 1} ( 3 ) ) \cdot Pr ( Y = {T}^{- 1} ( 1 ) ) ;$$

$${V}_{3} = Pr ( {Z}^{′} = 3 ) = Pr ( X = {S}^{- 1} ( 0 ) ) \cdot Pr ( Y = {T}^{- 1} ( 3 ) ) + Pr ( X = {S}^{- 1} ( 1 ) ) \cdot Pr ( Y = {T}^{- 1} ( 2 ) ) + Pr ( X = {S}^{- 1} ( 2 ) ) \cdot Pr ( Y = {T}^{- 1} ( 1 ) ) + Pr ( X = {S}^{- 1} ( 3 ) ) \cdot Pr ( Y = {T}^{- 1} ( 0 ) ) .$$

Although the modified random words X′ and Y′ contain the same entropy as the original random words X and Y, the random word Z′=X′⊕Y′ assumes the four possible values 0 to 3 with different probabilities than the random word Z=X⊕Y. The result is a new entropy value for Z′ (as opposed to Z).

The entropy of Z′=X′⊕Y′ is determined by

$$H ( {Z}^{′} ) = - {\sum }_{i = 0}^{3} {V}_{i} {log}_{2} ( {V}_{i} ) .$$

The choice of the S-boxes S and T used influences the entropy H(Z′). For example, an objective is to determine those S-boxes S and T for which H(Z′) is at a maximum. This can be achieved by determining the associated entropy H(Z′) for all possible pairs (S, T) of S-boxes. For example, that pair (S, T) for which the entropy H(Z′) assumes the maximum possible value can now be selected. In addition, it is also possible to take into account at least one target variable as part of multi-objective optimization: for example, it is possible to take into account only those S-boxes for which the implementation costs do not exceed a predefined threshold or it can be determined that the implementation costs are additionally intended to be as low as possible, with the result that a weighted optimization can be carried out between the objective of increasing the entropy and the objective of reducing costs. Different optimization strategies which result in the selection of suitable S-boxes are generally possible. For example, a suboptimum entropy value may suffice if it already complies with certain specifications and/or if the costs of the associated S-boxes are above a predefined threshold value.

### Example: Two Noise Sources, One Bijective S-Box

There are two memoryless noise sources which each generate random words with a width of 3 bits (that is to say 8 different symbols 0 to 7) with the following probabilities (pᵢ is the probability for the symbol i):

$${p}_{0} = 0.001 , {p}_{1} = 0.02 , {p}_{2} = 0.05 , {p}_{3} = 0.08 ,$$

$${p}_{4} = 0.16 , {p}_{5} = 0.17 , {p}_{6} = 0.2 , {p}_{7} = 0.319 .$$

The two noise sources produce random words with an entropy of 2.4783 bits or an entropy value of 82.62%.

One objective is now to increase the entropy of the combined random number. This is achieved, by way of example, using a single S-box.

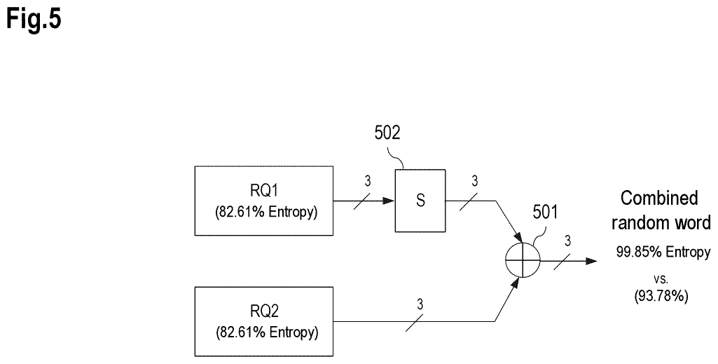

FIG. 5 shows an exemplary arrangement with two noise sources RQ1 and RQ2, wherein an S-box 502 is arranged in the path between the noise source RQ1 and an XOR gate 501. In this example, the S-box 502 is denoted S. It is, by way of example, a non-linear S-box which is determined by

$$S = ( \begin{matrix}01234567 \\ 07145263\end{matrix} ) .$$

The noise source RQ2 is connected directly to the XOR gate 501. The combined random number is provided at the output of the XOR gate 501.

As explained above by way of example, the two noise sources RQ1 and RQ2 provide random numbers with a width of 3 bits and with an entropy value of 82.61% for each noise source. As a result of the linking to the S-box 502, as shown in FIG. 5, the combined random number at the output of the XOR gate 501 can have an entropy of 2.9956 bits or an entropy value of 99.85% (in contrast to 2.8133 bits or 93.78% when the S-box 502 is omitted).

The algebraic description of the S-box 502 indicated here by way of example is determined by

$$S : ( x , y , z ) ↦ ( x + y + z , x + xy + yz , x + z ) ,$$

where x, y, and z are given by the three bits at the input of the S-box 502.

### Compression S-Boxes

A compression S-box is a function which maps binary words of the length n to binary words of the length m, where m<n. Using compression S-boxes in the group of noise sources makes it possible to achieve an additional compression of the entropy in the final (combined) random word. The final random word then already has a sufficiently high per-bit entropy in many cases, with the result that post-processing for increasing the entropy further can be omitted.

Dispensing with the post-processing reduces the costs in the hardware implementation of the random number generator. Furthermore, it is an advantage that random numbers can be generated at a higher data rate (that is to say more random numbers per time or in a shorter time).

In particular, it is hereby proposed to use improved or optimized compression S-boxes in the group of noise sources, with the result that the entropy of the combined random words is already sufficiently high and the post-processing can also be dispensed with for this reason.

Sufficiently high may mean, in particular, that the entropy value of the combined random word complies with a specification, for example from an authority, a customer or a standard. In many cryptographic applications, it is conventional to specify the quality of the random number on the basis of an entropy value which must be at least achieved.

### Example: Two Noise Sources, Two Compression S-Boxes

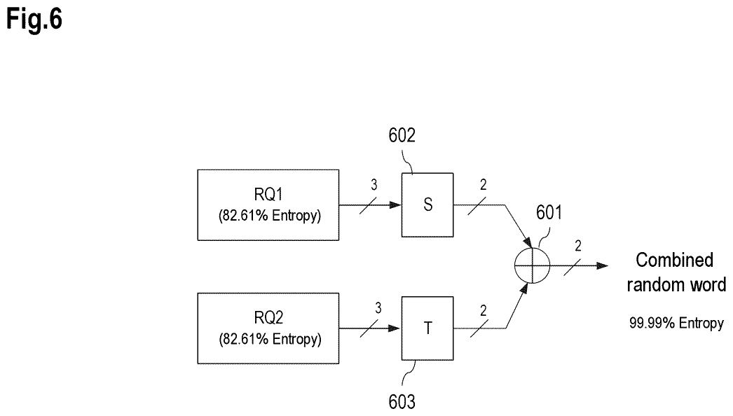

FIG. 6 shows the two noise sources RQ1 and RQ2 from FIG. 5 with identical probability distributions. In contrast to FIG. 5, an S-box S 602 is arranged in the path between the noise source RQ1 and an XOR gate 601 and a further S-box T 603 is arranged in the path between RQ2 and the XOR gate 601. Each of the S-boxes S and T compresses 3-bit words into 2-bit words.

Each of the two noise sources RQ1 and RQ2 generates random words with a length of 3 bits and an entropy of 2.4783 bits or an entropy value of 82.61%.

The S-boxes are defined, by way of example, as follows:

$$S = ( \begin{matrix}01234567 \\ 01322310\end{matrix} ) and T = ( \begin{matrix}01234567 \\ 01233210\end{matrix} )$$

As a result of the arrangement shown in FIG. 6, the entropy of the combined random word provided by the XOR gate 601 is increased to 1.99984 bits or 99.992%.

In this example, the S-boxes S and T are linear and may be represented as 2×3 matrices as follows:

$$S = ( \begin{matrix}110 \\ 011\end{matrix} ) and T = ( \begin{matrix}101 \\ 011\end{matrix} )$$

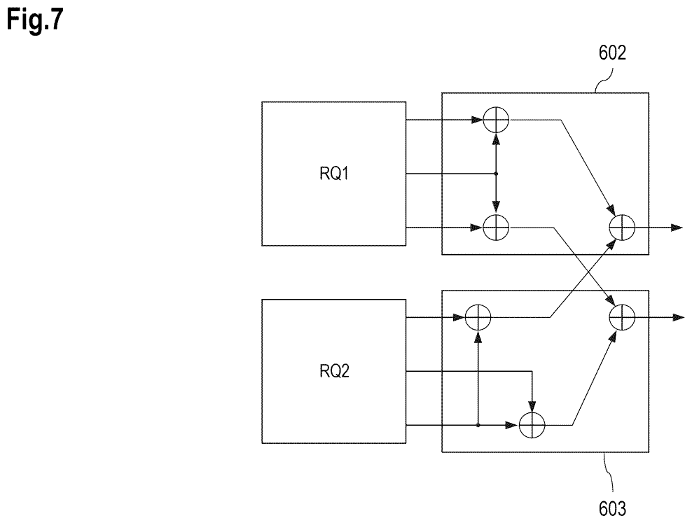

FIG. 7 shows an exemplary arrangement of a possible implementation of the S-boxes 602 and 603 by means of XOR gates, which is immediately clear from the 2×3 matrices shown above.

A combination of bijective and compression S-boxes can also be used in a group of noise sources. Furthermore, the individual noise sources may have different probability distributions if, for example, structurally identical noise sources are operated with different system parameters (for example different oscillators with different frequencies). Noise sources of different types or different designs can also be used.

### Example: Four Different Noise Sources

In this example, four different noise sources are intended to be combined with one another to form a group of noise sources.

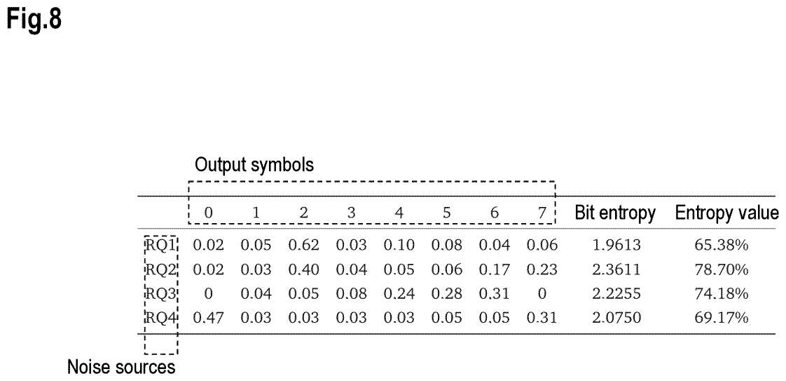

FIG. 8 shows a table with an exemplary probability distribution for each of the four noise sources: each of the noise sources generates eight symbols, which are denoted 0 to 7, for each unit of time. The noise sources RQ1 to RQ4 occupy lines 2 to 5 of the table. For example, the second entry 0.02 on the second line means that the noise source RQ1 generates the symbol 0 with a probability of p=0.02. The noise source RQ3 generates only six different symbols 1 to 6, and the symbols 0 and 7 are not generated by RQ3.

If the noise source generates the symbols 0 to 7 with the probabilities indicated in FIG. 8, the entropy of the 3-bit random word generated by the respective noise source is

$$h = - {\sum }_{i = 0}^{7} {p}_{i} {log}_{2} ( {p}_{i} ) .$$

In this case, pᵢ denotes the probability for the symbol i with i=0, . . . , 7. The last two columns in FIG. 8 indicate the bit entropy (that is to say the entropy of an output symbol of the noise source, which is a 3-bit random number or a random vector with a length of 3 bits) or the entropy value (also referred to as the percentage entropy value) for the respective noise source.

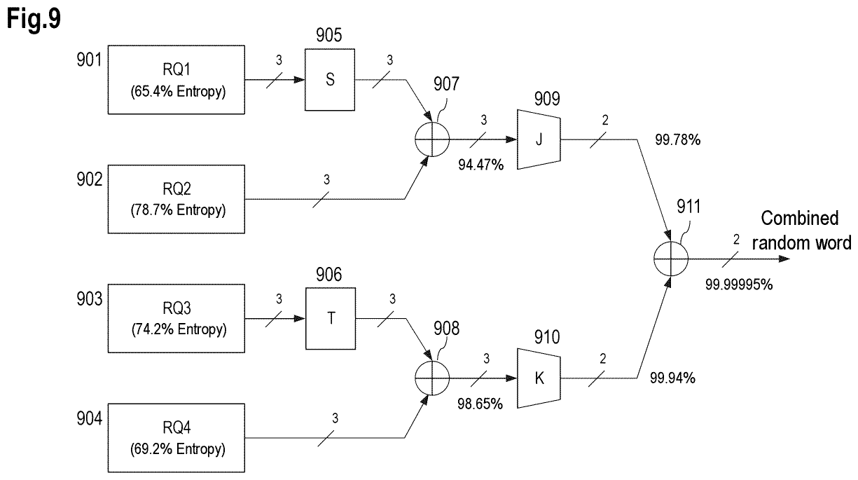

This group of noise sources is combined with S-boxes in the present example. FIG. 9 shows an exemplary arrangement comprising the four noise sources RQ1 to RQ4 which are mentioned here and are also denoted 901 to 904 in FIG. 9.

The noise source RQ1 901 delivers a 3-bit random word to a bijective S-box S 905, the output of which passes a modified 3-bit random word to the first input of an XOR gate 907.

The noise source RQ2 902 delivers a 3-bit random word to the second input of the XOR gate 907.

The noise source RQ3 903 delivers a 3-bit random word to a bijective S-box T 906, the output of which passes a modified 3-bit random word to the first input of an XOR gate 908.

The noise source RQ4 904 delivers a 3-bit random word to the second input of the XOR gate 908.

The output of the XOR gate 907 is connected to the input of a compression S-box J 909 which modifies the applied 3-bit random word into a compressed 2-bit random word and forwards it to the first input of an XOR gate 911.

The output of the XOR gate 908 is connected to the input of a compression S-box K 910 which modifies the applied 3-bit random word into a compressed 2-bit random word and forwards it to the second input of the XOR gate 911.

The combined 2-bit random word is available at the output of the XOR gate 911.

The noise sources RQ1 to RQ4 have the entropies indicated in FIG. 8. The arrangement according to FIG. 9 produces the following gradual increases in the entropy values:
at the output of the XOR gate 907: 94.47%,
at the output of the XOR gate 908: 98.65%,
at the output of the S-box J 909: 99.78%,
at the output of the S-box K 910: 99.94% and
at the output of the XOR gate 911: 99.99995%.

The S-boxes used here are determined, by way of example, as follows:

$$S = ( \begin{matrix}01234567 \\ 03746215\end{matrix} ) and T = ( \begin{matrix}01234567 \\ 07214356\end{matrix} ) ,$$

$$J = ( \begin{matrix}01234567 \\ 13130002\end{matrix} ) and K = ( \begin{matrix}01234567 \\ 01201323\end{matrix} )$$

The algebraic description of the S-boxes is:

$$S : ( x , y , z ) ↦ ( x + y + xz , x + y + z + xz , y + z + xz ) ;$$

$$T : ( x , y , z ) ↦ ( x + yz , x + y + yz , x + z + xy ) ;$$

$$J : ( x , y , z ) ↦ ( 1 + z , x + xz + xyz ) ;$$

$$K : ( x , y , z ) ↦ ( x + z + xy + xz + yz , y + xy + xz ) .$$

It is also noted that the approach presented here is highly robust. If one of the four noise sources fails, for example, the entropy value at the output of the XOR gate 911 is still at least 99.9%. This value exceeds the lower entropy limit of 99.7% required by the German Federal Office for Information Security.

A further advantage is that a total failure is identified as early as possible in accordance with the standards: since the combinational logic proposed here is memoryless, the same random words would always be provided at the output of the XOR gate 911 in the event of a total failure of all noise sources and the total failure would therefore be noticed immediately.

Noise Sources with Customized Digitizers

FIG. 4 explained above shows entropy compression by means of two S-boxes S and T to form a combined random word

$${Z}^{′} = {X}^{′} ⊕ {Y}^{′} = S ( X ) ⊕ T ( Y )$$

at the output of the XOR gate 401. This entropy compression is achieved, for example, by using bijective S-boxes S and T (for example determined by means of a computer search).

Another approach involves suitably modifying the noise sources involved, in particular their digitizers. The same applies to bundles of noise sources having more than two noise sources. This solution approach is advantageous from an implementation point of view (gate area, logical depth of the circuit, current consumption).

The noise source consists of two parts: the actual physical noise source and the digitizer.

### The Physical Noise Source

The physical noise source implements a physical random process. A random event (also referred to as a random experiment) takes place for each unit of time (determined by an external clock generator, for example the clock cycle of a processor unit). The result of the random experiment is represented by a measurement variable ξ which is an element of the so-called event space Ω: ξ∈Ω.

The event space Ω is the disjoint union of k=2ⁿ, n≥1, subregions A₀, A₁, . . . , Aₖ₋₁:

$$Ω = {A}_{0} ⋃ {A}_{1} ⋃ … ⋃ {A}_{k - 1} \\ with A i ⋂ {A}_{J} = ∅ for 0 \leq i < j \leq k - 1.$$

The output of the random experiment cannot be predicted. However, for each

$$i ∈ \{ 0 , 1 , … , k - 1 \} ,$$

the probability P(Aᵢ) of the measurement variable ξ landing in the subset Aᵢ is known. The k-tuple

$$( P ( {A}_{0} ) , P ( {A}_{1} ) , . . . , P ( {A}_{k - 1} ) ) \\ with P ( {A}_{i} ) \geq 0 for 0 \leq i \leq k - 1 and \\ P ( {A}_{0} ) + P ( {A}_{1} ) + … + P ( {A}_{k - 1} ) = 1$$

is referred to as the probability distribution of the noise source. The probability distribution of a noise source (used in practice) is known.

If the noise source (as assumed here) is memoryless, the (Shannon) entropy h of the noise source results from the probability distribution according to the formula

$$h = - {\sum }_{i = 0}^{k - 1} P ( {A}_{i} ) {log}_{2} P ( {A}_{i} ) \qquad ( 1 )$$

The entropy is therefore a pure property of the physical noise source and is independent of the configuration of the digitizer.

### The Digitizer

Let ξ∈Ω be the result of a random experiment. Since Ω is subdivided into k non-overlapping regions Aᵢ, there are k different events ξ∈Aᵢ that each occur with the probability P(Aᵢ), i=0, 1, . . . , k−1.

The digitizer converts each of the k possible events ξ∈Aᵢ into a uniquely determined symbol. Therefore, k different symbols are needed. The k symbols can be represented by integers 0, 1, . . . , k−1.

It is initially open which event is intended to be represented by which symbol. One possibility is the following assignment: the event ξ∈A₀ is represented by the symbol 0: if the event ξ∈A₀ occurs in the physical noise source, the digitizer generates the symbol 0 and this symbol 0 is output. If the event ξ∈A₁ occurs, the symbol 1 is generated and output. If ξ∈A₂ occurs, the symbol 2 is output, etc.

The digitizer implemented according to this assignment rule is referred to as a canonic digitizer for the noise source.

In principle, the k symbols 0, 1, . . . , k−1 can be assigned in any order to the k events ξ∈Aᵢ, i=0, 1, . . . , k−1. There are therefore

$$k ! = k ( k - 1 ) ( k - 2 ) … 3 \cdot 2 \cdot 1$$

possible ways of specifying the digitizer.

If, for example. k=8, there are 8!=40320 possible ways of implementing the digitizer. All of these variants result in a noise source with the same entropy. Let

$$π = π ( 0 ) , π ( 1 ) , … , π ( k - 1 )$$

also be any desired permutation (arrangement) of the k symbols 0, 1, . . . , k−1. The digitizer for the permutation r can be determined as follows: if the event ξ∈Aᵢ occurs, the symbol π(i) is generated and output, i=0, 1, . . . , k−1.

The following S-box defined by the permutation r is considered:

$$S = ( \begin{matrix}0 & 1 & … & k - 1 \\ π ( 0 ) & π ( 1 ) & … & π ( k - 1 )\end{matrix} ) .$$

π(i)=S(i) for all i∈{0, 1, . . . , k−1}. The permutation π therefore defines a bijective S-box. Conversely, a given bijective S-box

$$S : \{ 0 , 1 , … , k - 1 \} \to \{ 0 , 1 , … , k - 1 \}$$

defines the associated permutation π:=S(0), S(1), . . . , S(k−1) of the k symbols 0, 1, . . . , k−1.

There are therefore, in particular, the following two variants: variant (A) is a physical noise source with a canonic digitizer and a downstream S-box S. Variant (B) comprises a noise source without an S-box, wherein the digitizer of the noise source is implemented according to the permutation

$$π = S ( 0 ) , S ( 1 ) , … , S ( k - 1 ) .$$

Both variants (A) and (B) always produce the same output symbol for each event ξ∈Aᵢ. This output symbol appears at the output of the S-box S in variant (A) and the output symbol is directly provided by the digitizer of the noise source in variant (B).

It is therefore also proposed that noise sources with specially defined digitizers can be used in a group of noise sources (as shown, for example, in FIG. 1). Such digitizers implement permutations, for which the entropy of the combined random word is increased and in particular optimized. Suitable permutations can be determined in advance by means of a computer search.

In this case, it shall be noted that, in the first approach, the noise sources are provided with external real S-boxes, whereas, in the second approach, the same S-boxes are included internally and virtually in the digitizer.

To explain the term “digitizer”: k=2n. If, for example, the case k=16 is considered, n=4. The physical noise source may assume 16 different internal states ξ∈Aᵢ, 0≤i≤15. The associated 16 symbols in the digitizer are determined as 0, 1, . . . , 15. In the hardware implementation of the noise source, these symbols are represented by binary vectors having a length of four bits. For example, the symbol 15 is represented by the vector (1, 1, 1, 1). Therefore, the event ξ∈A₁₅ is digitized into the vector (1, 1, 1, 1) in the physical noise source.

### Example: Noise Sources with Digitizers

In the example shown in FIG. 5, there are the two noise sources RQ1 and RQ2 which use the same physical random process. Eight different events ξ∈Aᵢ, 0≤i≤7, may occur for each noise source. The probabilities pᵢ=P(Aᵢ)=Pr(ξ∈Aᵢ) for the occurrence of the individual events are given by:

$${p}_{0} = 0. 001 , {p}_{1} = 0.02 , {p}_{2} = 0.05 , {p}_{3} = 0.08 , \\ {p}_{4} = 0.16 , {p}_{5} = 0.17 , {p}_{6} = 0.2 , {p}_{7} = 0.319 .$$

Each noise source generates (in each step)

$$h = - {\sum }_{i = 0}^{7} {p}_{i} {log}_{2} {p}_{i} = 2.4783$$

bits of entropy, that is 82.61% of the maximum possible entropy (=3) for a random vector having a width of three bits.

In the example in FIG. 5, it was assumed that the two noise sources contain identical (canonic) digitizers. The XOR gate 501 then extracts the maximum entropy if one of the two noise sources is provided with the bijective S-box

$$S = ( \begin{matrix}01234567 \\ 07145263\end{matrix} ) .$$

The maximum entropy of 99.85% is also achieved if the digitizer of a noise source is implemented according to the permutation

$$π = 0 , 7 , 1 , 4 , 5 , 2 , 6 , 3$$

If identical digitizers were used in both noise sources, the combined random word at the output of the XOR gate 501 would achieve only an entropy value of 93.78%.

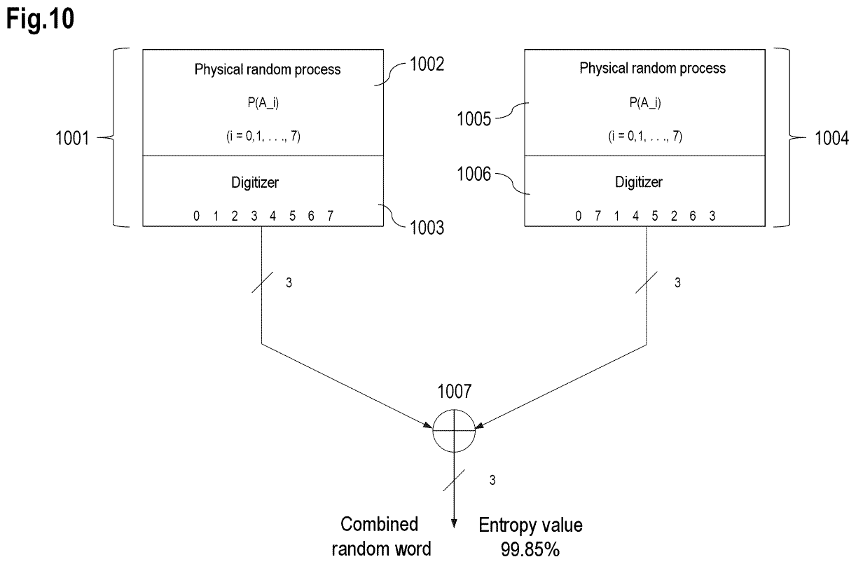

FIG. 10 shows an arrangement for increasing the entropy by modifying a digitizer arranged in the noise source.

A noise source RQ1 1001 comprises a physical random process 1002 and a digitizer 1003, and a noise source RQ2 1004 comprises a physical random process 1005 and a digitizer 1006.

The digitizer 1003 delivers a random word with a width of 3 bits to the first input of an XOR gate 1007, and the digitizer 1006 delivers a random word with a width of 3 bits to the second input of the XOR gate 1007. Combined random words with a width of 3 bits and having the entropy value 99.85% are provided at the output of the XOR gate 1007.

The digitizer 1003 is implemented according to the permutation

π=0,1,2,3,4,5,6,7

and the permutation

π=0,7,1,4,5,2,6,3

is implemented in the digitizer 1006.

The XOR gates which are shown in the examples and have the inputs with a width of 3 bits can be implemented using three XOR gates with only two inputs by carrying out a bit-by-bit XOR combination, for example:

$$4 XOR 7 = ( 0 , 0 , 1 ) XOR ( 1 , 1 , 1 ) = ( 0 ⊕ 1 , 0 ⊕ 1 , 1 ⊕ 1 ) = ( 1 , 1 , 0 ) = 3.$$

1. A method for increasing the entropy of a random number,
in which a plurality of random processes each provide a random number, and
in which the plurality of random numbers are linked to form a combined random number, wherein at least one of the random numbers has previously been mapped to another random number.

2. The method of claim 1, in which the combined random number is used in a cryptographic method.

3. The method of claim 1, in which each random process comprises at least one physical random process.

4. The method of claim 3, in which the random number is mapped to the other random number by means of at least one S-box.

5. The method of claim 4, in which the S-box is a bijective S-box or a compression S-box.

6. The method of claim 1, in which the random process and a digitizer are part of a noise source.

7. The method of claim 6, in which the random number is mapped to the other random number by means of the digitizer.

8. The method of claim 1, in which the plurality of random numbers are linked to form the combined random number by means of at least one XOR combination, in particular by means of at least one XOR gate.

9. The method of claim 1, in which that mapping of the at least one random number to the other random number which increases the entropy of the combined random number is determined.

10. The method of claim 9, in which that mapping of the at least one random number to the other random number which increases the entropy of the combined random number is determined by testing a multiplicity of mappings.

11. An apparatus for increasing the entropy of a random number, having a processing unit configured to carry out the steps of the method of one claim 1.

12. An apparatus for increasing the entropy of a random number,
having a plurality of random number generators, each of which provides a random number,
having at least one mapping unit which can be used to map at least one of the random numbers to at least one other random number,
having a combining unit which is coupled to the random number generators and to the at least one mapping unit in such a manner that a combined random number can be determined on the basis of the random numbers and the at least one other random number.

13. The apparatus of claim 12, in which the mapping unit comprises at least one bijective and/or at least one compression S-box.

14. The apparatus of claim 12, in which the combining unit comprises at least one XOR combination.

15. The apparatus of claim 12, in which the random number generator and the mapping unit are part of a noise source.
